(19) United States
(12) Patent Application Publication
(10) Pub. No.: US 2006/0255177 A1
(43) Pub. Date: Nov. 16, 2006

(54) Apparatus and method for securing a lawn sprinkler

(75) Inventors: Mike Heatwole, Canadian, TX (US); Randy Walser, Canadian, TX (US)

Correspondence Address: Samuel Brown Silverman, 510 South Polk Street, Amarillo, TX, 79101-2318, US

(73) Assignee: Mike Heatwole

(21) Appl. No.: 11/124,014

(22) Filed: May 6, 2005

(51) Int. Cl. A62C 31/22

(52) U.S. Cl. 239/276; 239/273

(57) ABSTRACT

This invention, in at least certain embodiments, is directed to an improved apparatus for securing a lawn sprinkler by use of radially-extending, laterally-disposed subterranean or subsurface blades or blade structures. The apparatus in at least certain embodiments of the present invention includes a base. The base has a top, a bottom, at least one exterior side, a longitudinal axis and a radius. An aperture, generally centered along the longitudinal axis, extends through the base. A sprinkler head is mounted at the top of the base along the longitudinal axis. An irrigation fluid source is connected at the bottom of the base, also along the same longitudinal axis. Generally horizontally and radially extending from the side of the base is at least one position securing element. The one position securing element has a horizontal axis which extends radially outward from the longitudinal axis, and at least side of at least one blade is positioned along the horizontal axis.

### 1. FIELD OF THE INVENTION

The present invention pertains to an apparatus and method for securing irrigation systems, namely lawn sprinklers, comprised of below-ground level water-carrying conduit networks.

### 2. DISCLOSURE DOCUMENT FILING REFERENCE

This invention was the subject of U.S. Patent Office Disclosure Document Number 572317, filed Mar. 8, 2005, entitled, APPARATUS FOR SECURING A LAWN SPRINKLER.

### 3. BACKGROUND OF THE INVENTION

The present invention relates to a novel horizontal position-securing element which secures the sprinkler head at a fixed position in the ground by retaining the conduit section below ground level with the dispensing end element above or slightly below ground level.

Sprinkler heads are positioned to dispense or disperse water over a specified area for coverage. In many applications, such as athletic fields, golf courses, sculptured gardens and the like, the placement of the water is accomplished by the precise placement of a sprinkler head. However, in the course of using the lawn, garden or field, heads frequently moved or shift, and water is dispensed to locations not desired. For instance, while sprinkler heads can spray water over a specifically-sized arc or swath near a corner or a curved path, water sprayed on the path is an obstacle or safety hazard, and a waste of water, more than merely a nuisance to the owners, athletes, grounds users, or maintenance crew. Frequently, the cause of the misdirected spray or underground leaks is the lateral or rotational movement of the subterranean portion of a sprinkler head or water line.

In the specific applications of athletic fields, golf courses, sculptured gardens and the like, sprinkler heads protrude upwardly from the ground in or near high-traffic areas. The shallow depth of the position of the sprinkler heads entails specific problems. First, the ground near the sprinkler head is frequently the most disturbed soil, and compaction becomes irregular. With irregular compaction, water is absorbed at different rates and to differing levels of saturation in the immediate vicinity of the sprinkler head, thus making motion possible when the sprinkler head is disturbed, either by a foot, equipment, pressure or torque caused by water pressure in the subsurface conduits, pressure or torque caused by water moving in the subsurface conduits, or just the motion of the surrounding soil by nearby activity. The position of the sprinkler heads thus requires adjustment; and adjustment of the position frequently entails further disruption of the soil, thus perpetuating the same problem.

Water conservation is a priority a priority for the irrigation industry. Misdirected hydration wastes water, a precious and expensive commodity. Because of environmental concerns arising from the allocation of water for various purposes and runoff into municipal water treatment systems as well as absorption into the ground, the precise application of water on a ground surface is a goal towards which this invention is directed.

Safety is another specific problem associated anchoring this type of sprinkler head. While permanence and stability is desired, anchors that may cause damage to equipment or personnel preclude the extensive use of subterranean anchoring means. The elongated spikes, sharp installation blades or sharpened fin elements of many gardening or agricultural sprinkler support structures present physical dangers to people and equipment, including other underground tubes and piping as well as buried cables.

Three problems pertain to: (1) the undesirable repositioning of a sprinkler head either through use or unintended contact; (2) damage caused to the ground beneath and around a sprinkler head from the motion, incorrect hydration, or disturbance of the surface soil securing the positioning of the sprinkler head; and, (3) necessity for both safely anchoring and easily readjusting or correcting the position of a sprinkler head.

Currently available art does not satisfactorily address these common problems. The limited relevant prior art addresses these problems with a variety of spike-like structure for insertion into the ground. The lateral or rotational movement is generally addressed by the use of one or more prong-like stakes inserted into the ground. The prior art structures of one or more long or multi-sided vertical stake elements do not address the specific problems of the partially subterranean sprinkler head, namely the undesirable movement of a sprinkler head.

In certain prior art, the basic design criteria for securing the position of a water-sprinkling means employed one or more vertical spike structures for insertion deep into the ground. Depth of the insertion was the important structural consideration in the utility of the apparatuses disclosed. None of these prior art structures addresses the problem solved by the present invention, namely the easily implanted, but securely positioned, and precise placement of a sprinkler head to effect a particular spraying pattern or hydration need of a particular area.

Until this invention, there was no comparable cost-effective structure to securely position a sprinkler head which would address the need for lateral support for the precise placement of a sprinkler head.

### 4. DESCRIPTION OF RELATED ART

Apparatuses for securing irrigation or lawn sprinklers have been limited in certain prior art systems to employing a variety of spike elements.

U.S. Pat. No. 5,678,909 (Dean) employs an elongated tapered spike attached to a first end of an offset element, which allows a user to impart substantial force in driving the spike vertically into the ground without damaging sprinkler head, and a web for preventing rotation of the spike. A sprinkler coupling is attached at a second end of the offset.

U.S. Pat. No. 3,994,441 (Testa) employs an elongated member with a spike element, a channel portion and a footstep for insertion of the spike element into the ground. A sprinkler nozzle is located at the top of the elongated member and is attached to a tube which is located in the channel portion. The lower end of the tube provides for connection to a conventional hose socket on or above the ground surface.

U.S. Pat. No. 4,801,089 (Zeman) employs an elongated stake with a hammer pad attached to an offset body portion, which houses a sprinkler element. While the invention is not specifically limited to a water supply structure located on or above the ground surface, the ease of removability and interchangability of components for cleaning or substitution infer that the sprinkler structure is located above the ground surface.

U.S. Pat. No. 4,256,262 (Rosenberg) employs an vertical post attached at one end to a ground stake. A cylindrical horizontal socket for receiving a mounting for an above-ground water sprinkling element is attached to the opposite end of the vertical post. The vertically-disposed ground stake includes a solid, pointed conical end with four tapered ribs disposed at right angles to one another.

U.S. Design Pat. No. D497,973 (Schapper) is an ornamental design for a spike for a lawn sprinkler. The structure illustrated comprises a tapered spike with four orthogonally disposed elements mounted in the center of a base upon which are also mounted on the same side of the base with two generally triangularly-shaped elements. Each of the two generally triangularly-shaped elements has a curved and outwardly-oriented face and a flat triangularly-shaped inwardly-oriented face symmetrically placed near opposing edges of the base and axially-oriented perpendicular to the base. The centerline of each generally triangularly-shaped elements is parallel to each other and collinear with an axis formed between two opposing elements of the four orthogonally disposed elements. The sprinkler connection appears to accommodate a conventional hose socket on or above the ground surface.

U.S. Pat. No. 4,944,476 (Olson) is an elongated one-piece stabilizing stake, with a centerline and a lower tip, for insertion into the ground for retaining a flexible irrigation conduit. Constituent fin members of the stake project radially from the centerline and taper to the lower tip.

U.S. Pat. No. 4,850,555 (Lemkin) employs at least one elongated stake element with a tip and a specific configuration to permit the coupling of more than one stake elements along a common longitudinal axis to provide greater elevation to the sprinkler location. The multi-lobed cross-section stake element may be x-shaped, y-shaped or t-shaped, as these specific cross-sectional varieties contribute to the strength of the stake above the ground. The tip is adapted to anchor the stake to the ground.

U.S. Pat. No. 4,779,800 (Tuomi) is an above-ground watering system for a lawn or garden which employs a position-securing wire stake. The wire stake comprises a central loop, for securing the position of the water hose, and a pair of legs. When the pair of legs are brought together and pushed into the ground, the central loop is slightly closed, thus securely gripping the water hose.

U.S. Pat. No. 4,824,019 (Lew) is a continuous lawn-border sprinkler being a series of longitudinal members, each consisting of a single continuous anchoring leg and a continuous water-dispensing border leg. The anchoring leg protrudes at a 90 degree angle from the border leg; as the component sprinkling conduit is continuous, the border leg is continuous as well.

U.S. Pat. No. 4,945,675 (Kendrick) is a lighted lawn divider with a watering means. The lawn divider includes a continuous structure which is anchored to the ground surface by downwardly-extending spikes.

U.S. Pat. No. 5,439,176 (Bussiere) employs an above-the-ground tripod support structure, with a spindle axis, to support both a above-ground sprinkling apparatus and a water-supplying conduit. Only the terminal ends of the support rods of the tripod extend both downward and parallel to the spindle axis to facilitate insertion into the ground for support.

U.S. Pat. No. 4,997,997 (Moore) describes a sprinkler head attached to the end of a horizontally-extending arcuate-shaped structure with an elongated slot for holding a coiled garden hose. The framework is stabilized by a support stand and is therefore designed to be left on the ground unattended. A retainer spike may be pressed down into the earth to help retain the sprinkler in position.

The art relating to securing lawn sprinklers relates generally to above-ground sprinkling apparatuses. Elevating the sprinkler head to a desired height for irrigation coverage appears to be the main purpose of the subterranean elements employed in the prior art. There is no teaching or suggestion pertaining to securing the position of subterranean sprinkler heads by way of relevant radially-extending, generally laterally-disposed blades or other like elements.

### 5. SUMMARY OF THE INVENTION

This invention, in at least certain embodiments, is directed to an improved apparatus for securing a lawn sprinkler by use of radially-extending, laterally-disposed subterranean or subsurface blades or blade structures. The invention addresses a previously unaddressed or inadequately addressed need in the industry. To the extent that any prior art addresses the subject matter of this invention, the disclosed invention overcomes the disadvantages and shortcomings of the prior art described above. To the extent that elements or any combination of elements of the available prior art addresses the subject matter of this invention, no elements anticipate the invention disclosed herein, nor do any of the prior art teach any combination to anticipate the invention disclosed herein.

The apparatus in at least certain embodiments of the present invention includes a base. The base has a top, a bottom, at least one exterior side, a longitudinal axis and a radius. An aperture, generally centered along the longitudinal axis, extends through the base. A sprinkler head is mounted at the top of the base along the longitudinal axis. An irrigation fluid source is connected at the bottom of the base, also along the same longitudinal axis. Generally horizontally and radially extending from the side of the base is at least one position securing element. The one position securing element has a horizontal axis which extends radially outward from the longitudinal axis, and at least side of at least one blade is positioned along the horizontal axis.

Accordingly, it is an object of the present invention to provide a stable, non-moving subsurface base to which a sprinkler head is attached.

It is a further object of the present invention to provide an easily installed stable base for securing the position of a lawn sprinkler by employing one or more laterally positioned blades with sufficient surface area to contact the surrounding soil and anchor the sprinkling equipment to a specific location to effect hydration of a specific region.

These and other objects and advantages of the present invention, as well as details of certain preferred embodiments thereof will be more fully understood from the following description and the drawings.

### 6. BRIEF DESCRIPTION OF THE DRAWINGS

FIG. 1 is an isometric drawing of the invention showing the relationship of the elements of the invention.

FIG. 2 is a front view of the invention.

FIG. 3 is a cross-section view of this embodiment of the invention along the horizonal axis of one position-securing element and through the longitudinal axis of the base.

FIG. 4 shows a bottom view of the invention.

### 7. DESCRIPTION OF CERTAIN PREFERRED EMBODIMENTS

As shown in the Figures, one embodiment of the apparatus (10) comprises a base (11) with an aperture (17) and at least one position securing element (20).

The base (11) has a top (12), a bottom (13), at least one exterior surface (14), at least one interior surface (32), a longitudinal axis (15) and a radius (16). The base (11) also has an aperture (17), bounded by the at least one interior surface (32) and generally centered along the longitudinal axis (15) of the base (11). A first periphery (33) opens at the bottom (13) of the base (11). A second periphery (34) opens at the top (12) of the base (11).

The second periphery (34) defines the opening of the aperture (17). Generally circular in shape, the center of the aperture (17) lies within the longitudinal axis (15) of the base (11). At the top (12) of the base (11), the aperture (17) is generally cylindrical in shape, the axis of which aperture (17) is collinear with the longitudinal axis (15), which extends through the center of the base (11).

The base (11) includes a bottom (13). The first periphery (33) defines the aperture (17) which opens to the bottom (13) of the base (11). In certain embodiments, the first periphery (33) is generally circular in shape, and the center of the aperture (17) at the first periphery (33) lies within the longitudinal axis (15) of the base (11). At the bottom of the base (11), the aperture (17) is generally cylindrical in shape, the axis of which aperture (17) is collinear with the longitudinal axis (15) of the base (11). Thus, in certain embodiments, the longitudinal axis (15) extends through the center of the aperture (17).

In one embodiment, as illustrated in drawings, the base (11) is generally cylindrical. As at least one interior surface (32) which defines the aperture (17) in certain embodiments generally has a circular cross-section, the corresponding shape of the base (11), and its exterior surface (14) in certain embodiments would also be generally cylindrical as well and as illustrated in the drawings. However, in certain other embodiments, depending on the environment and number of position securing elements (20) attached or attachable to the exterior surface (14) of the base (11), the base (11) may be a one from variety of shapes, both symmetrical and asymmetrical, to accommodate the particular version of that embodiment.

As shown in the drawings, at least one interior surface (32) which defines the aperture (17) also defines a fluid-conducting passage (36), which passage (36) provides for fluid communication to a discharge element (19). Fluid-conducting passage (36) permits the passage of fluid, namely water for irrigation or hydration, to pass from the fluid-conducting conduit (18), through the base (11), to the discharge element (19) and to the sprinkler head (30).

In the embodiment shown, a sprinkler head (30) is attached to the top (12) at the second periphery (34). In this embodiment illustrated by the drawings, the discharge element (19) is represented by a male element inserted into a first receiving cavity (31) located in the sprinkler head (30).

The attachment means connecting the discharge element (19) to the first receiving cavity (31) includes those types as is normally employed in the art. Many common fittings employ a compression fitting or a sleeve. Other common fittings employ threaded elements for attachment to a discharge element (19) or a sprinkler head (30). Different embodiments of the base (11) are to accommodate those common fittings.

In the embodiment illustrated in the drawings, the first periphery (33) includes a threaded female element for receiving the fluid-conducting conduit (18). In certain embodiments, the first periphery (33) is adapted to connect to a fluid-connecting conduit (18). In embodiment shown in the drawings, the first periphery (33) shown is an attachment means attaching the base (11) to the fluid-conducting conduit (18) and corresponds to the mating arrangement employed between the discharge element (19) and the first receiving cavity (31) as is normal in the art. In other embodiments, the mating arrangement employed between the discharge element (19) and the second periphery (34) need not match, but are included or attached to the base (11) as is normal in the art to accommodate the equipment to be attached.

In certain embodiments, the second periphery (34) is adapted to connect to the discharge element (19). In an embodiment shown in the drawings, the second periphery (34) shown is an attachment means attaching the base (11) to the discharge element (19) to the first receiving cavity (31) of and to the sprinkler head (30). As with the first periphery (33), the mating arrangement employed between the discharge element (19) and the first receiving cavity (31) would be as normally employed in the art. In other embodiments, the mating arrangement employed between the discharge element (19) and the first periphery (33) and the second periphery (34) need not match, but are included or attached to the base (11) as is normal in the art to accommodate the equipment to be attached.

In certain embodiments, the discharge element is a sprinkler head (30). While the embodiment illustrated by the drawings shows the attachment of a conventional sprinkler head (30) to the top (12) of the base (11), in certain embodiments discharge element is itself sprinkling element or a sprinkler head (30).

As illustrated by the drawings, this invention further includes at least one position securing element (20). The at least one position securing element (20) has a horizontal axis (21) and at least one blade (22). The at least one blade (22) includes a proximal end (25), attached to the at least one exterior surface (14) of the base (11), at least one face (24), a lower side (27), a distal end (26), a cross-sectional profile (35), and at least one side (23) positioned along the horizontal axis (21).

In certain embodiments, the at least one face (24) of the at least one blade (22) is flat. As illustrated in the drawings, the embodiment shown of the at least one face (24) is planar. This embodiment illustrates one of the simpler versions for the structure of the at least one face (24). However, in other embodiments, the at least one face (24) may have a convex surface, a concave surface, a corrugated surface, or an irregular surface, according to the particular type of environment in which the apparatus (10) may be employed.

The relationship of the surface area of the at least one blade (22) to the volume of the dirt compacted about the apparatus (10) is directly related to the stability the apparatus (10) enjoys when installed. The greater the total number of constituent blades (22) employed, the greater the surface area available to contact the surrounding dirt or fill material around the apparatus (10); however, as the number of blades (22) or surface area increases, the lower the volume of dirt or fill material around the apparatus (10). Given the cohesive quality of dirt or fill material, and the fact that the cohesive qualities of the ground material may vary according to composition, water content, or other constituent matter in the soil, dirt or fill material, the optimal number of blades or surface area to be employed in various embodiments may vary according to application and environments. Given the variety of environments in which lawn sprinkling apparatuses are employed, it is contemplated that the variety of embodiments will vary with the number of constituent elements, namely number of blades (22) and position securing elements (20) of the apparatuses (10).

In certain embodiments, the proximal end (25) of the at least one blade (22) is parallel to the longitudinal axis (15). As illustrated in the drawings, the embodiment shown of the at least one face (24) is planar, and in this embodiment, the cross-sectional profile (35) of the blade is rectangular thus illustrating how the proximal end (25) of the planar face (25) is generally parallel to the longitudinal axis (25) of the base (11). With this rectangular cross-sectional profile, this embodiment illustrates one of the simpler versions for the structure of the at least one face (24).

In other embodiments, the at least one face (24) may have a convex surface, a concave surface, a corrugated surface, or an irregular surface, according to the particular type of environment that the apparatus (10) may be employed. The axial orientation of the shape of the cross-section of these embodiments may be parallel to the longitudinal axis of the base (11) as well.

In certain embodiments, the distal end (26) of the at least one blade (22) is parallel to the longitudinal axis (15). As illustrated in the drawings, the embodiment shown of the at least one face (24) is planar, and in this embodiment, the cross-sectional profile (35) of the blade is rectangular thus illustrating how the distal end (26) of the planar face (24) is generally parallel to the longitudinal axis (15) of the base (11). With this rectangular cross-sectional profile, this embodiment illustrates one of the simpler versions for distal end (26) of the at least one face (24).

In other embodiments, the distal end (26) of the at least one blade (22) may have a cross-sectional profile (35) reflecting a convex surface, a concave surface, a corrugated surface, or an irregular surface. The shape of this embodiment may be dictated according to the composition of the particular type of environment in which the apparatus (10) may be employed. The axial orientation of the shape of the cross-section of these embodiments of the distal end (26) may be parallel to the longitudinal axis of the base (11) as well.

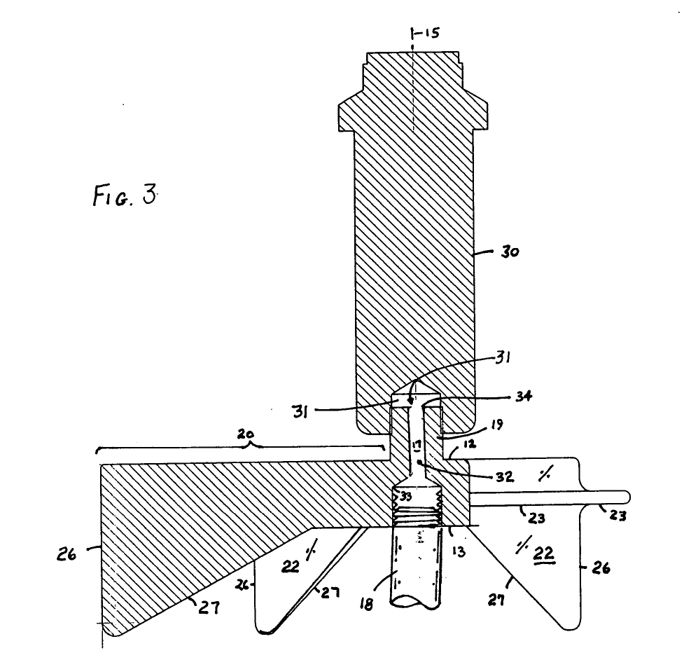

As illustrated in FIG. 2, the at least one blade (22) also has a proximal end (25) and a distal end (26). The proximal end (25) is attached to the at least one exterior surface (14) of the base (11).

The lower side (27) of the at least one blade (22) extends from the bottom of the proximal end (25) to the bottom of the distal end (26). In certain embodiments, the bottom of the proximal end (25) is located at or near the bottom (13) of the base (11). In certain embodiments, the slope from the bottom of the proximal end (25) of the lower side (27), to the bottom of the distal end is generally parallel to the horizontal axis (21).

In yet other embodiments, the slope from the bottom of the proximal end (25) of the lower side (27), to the bottom of the distal end is tapers downwardly, relative to the bottom (13) of the base (11), to the bottom of the distal end (26) of the blade (22). The drawings illustrate an embodiment with a downward taper from the bottom of the proximal end (25) to the bottom of the distal end (26).

The function of the laterally-extending blade (22) is to engage the dirt, soil and fill material of surrounding the apparatus (10). The amount of surface area as well as the cohesive and adhesive qualities of the dirt, soil and fill material of surrounding the apparatus (10) have bearing on the shape and number of blades (22) and position securing elements (20) to be employed. The sides of the blade act like a paddle in engaging the dirt, soil and fill material by employing the stability of the local earth to stabilize the position of the sprinkler head to be secured. Inasmuch as stability and position security are relative to the placement in the ground surface in which the sprinkler is located, the apparatus of this invention provides improved stability and position-securing qualities.

By having blades (22) extend laterally outward from the base (11), rather than downwardly as suggested by the prior art, the apparatus of this invention takes advantage of a larger area of the ground surface from which to draw stability. As the sprinkler heads in lawns are generally located at or slightly below or slightly above the ground surface, lateral dislocation occurs due to movement of the soil at or close to the ground surface. Motion or displacement is frequently caused by inadvertent contact with items in the ground, upwelling immediately beneath the sprinkler head and rotation caused by the motion of water travelling through the fluid conducting conduit (18). By employing one or more laterally-extending elements (20) and its constituent blades (22), the apparatus of this invention greatly increases the contact area with, and thus stability with respect to, the surrounding ground surface.

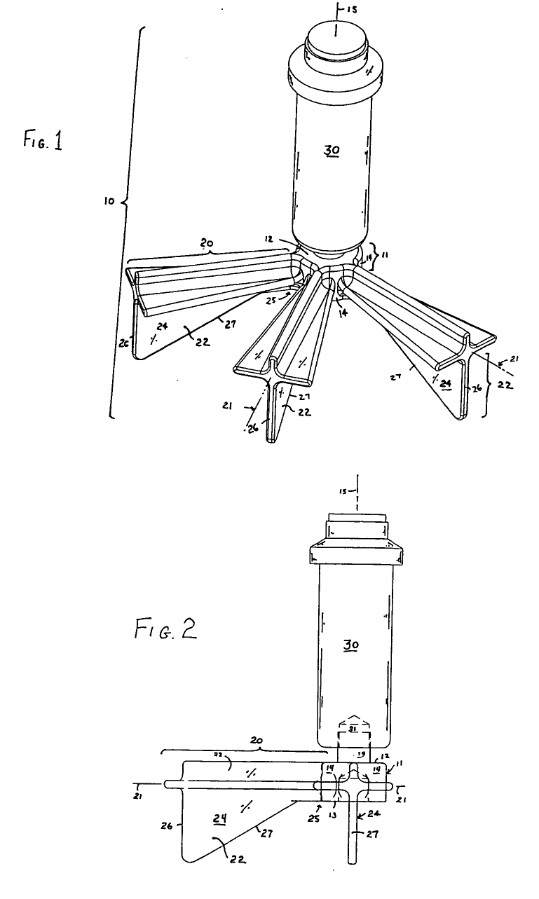

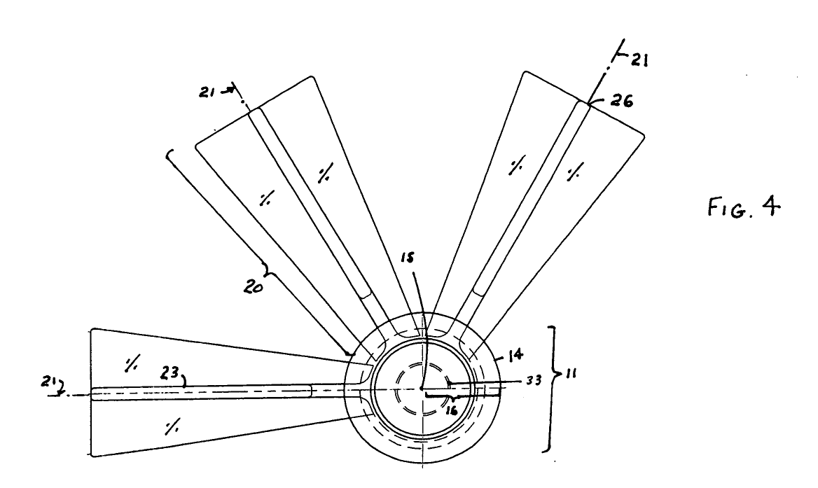

The drawings illustrate one embodiment of the position securing element (20) with four blades (22). In this embodiment, the at least one side (23) of each of the four at least one blades (22) illustrated meet along a common axis. In this embodiment, the common axis shares the horizontal axis (21). In the embodiment shown in FIGS. 1-4, each face (24) of the blades (22) are orthogonal to one another, thus providing stability to the base (11) and sprinkler head (30).

In certain embodiments, the at least one position securing element (20) has a cross-sectional shape comprising the cross-sectional profile (35) of each of the at least one blade (22).

In other embodiments, the at least one position securing element (20) has a cross-sectional shape selected from the group consisting of a T-shape, an X-shape, a Y-shape, a cross-shape and an O-shape. The cross-sectional shape employed is influenced by the composition of the particular type of dirt, soil, fill material or other environmental qualities in which the apparatus (10) may be employed. Sandy soil, soil with more clay, fill material with more sand or aggregate, or dirt with a variety of density, water content, gas content, mineral composition, and other qualities, are environments which may each require different-shaped elements to optimize stability and position-securing qualities.

In certain embodiments, the horizontal axis (21) of the at least one position securing element (20) is perpendicular to the longitudinal axis (15) of the base (11). In other embodiments, the horizontal axis (21) of the at least one position securing element (20) extends tangentially from the exterior surface (14) of the base (11).

In yet other embodiments, the horizontal axis (21) of the at least one position securing element (20) is collinear with the radius (16) of the base (11).

In certain embodiments, the at least one position securing element (20) is at least two position securing elements separated by an angle selected from a group consisting of less than ninety degrees, greater than ninety degrees, and ninety degrees.

As illustrated by the drawings, this embodiment of the invention comprises three position securing elements (20), positioned sixty (60) degrees apart, and in a plane generally perpendicular to the longitudinal axis (15) of the base (11).

Different environments may require different positions for the at least one position securing elements (20). It is contemplated that other embodiments may include positioning one or more of the position securing elements (20) in a plane generally perpendicular to the longitudinal axis (15) of the base (11) at one or more of the following positions: the zero (0) degree position; the sixty (60) degree position; the one hundred twenty (120) degree position; the one hundred eighty (180) degree position; the two hundred forty (240) degree position; or, the three hundred (300) degree position.

In certain embodiments, the base (11) and the proximal end (25) of the at least one blade (22) of the at least one position securing element (20) are a single structure. Certain embodiments of the apparatus (10) of this invention will find the base (10) and the at least one position securing element (20) formed as one integral unit, such as may be accomplished from a plastic mold or metal forming, as is normal in the respective arts.

In other embodiments, the base (11) and the proximal end (25) of the at least one blade (22) of the at least one position securing element (20) are removably attached. Certain embodiments of the apparatus (10) of this invention will find the base (10) and the at least one position securing element (20) formed as separate units and removably attached. Different applications, in either manufacturing or in use of the apparatus, may benefit from having the elements of the invention separate and removably attachable. This would permit ease in manufacturing and adapting the apparatus (10) to the environment during installation or in the course of maintenance. The feature of removable attachment may be accomplished by a variety of means, as is normal in the art, including, but not limited to as form-fitting interlocking components, snap elements, screws, pins, and adhesives, as is normal in the respective arts.

The invention includes the method for securing a lawn sprinkler beneath a ground surface, the lawn sprinkler having a fluid-conducting conduit and a sprinkler head, the method consisting of: connecting the fluid-conducting conduit to the first periphery (33) at bottom (13) of base (11) of the apparatus (10) of this invention; connecting the sprinkler head (30) second periphery (34) located at the top (12); positioning the apparatus (10) in a cavity beneath the ground surface; and, surrounding at least one position securing element (20) of the apparatus (10) with a sufficient volume of dirt or fill material to contact at least one face (24) of the at least one blade (22) to securely position the apparatus (10) beneath the ground surface.

The positioning of the apparatus (10) in a cavity beneath the ground surface is such that the fluid-conducting conduit is positioned generally beneath the apparatus. The positioning of the apparatus (10) is also such that the sprinkler head (30) is positioned generally above the apparatus but amenable to discharging hydrating fluid at or above the ground surface.

When the apparatus (10) is placed in position, surrounding the at least one position securing element (20) of the apparatus (10) is a sufficient volume of dirt or fill material to contact the at least one face (24) of the at least one blade (22) to secure the position for the apparatus (10) beneath the ground surface. Thus, motion or force at shallow depths below ground level is either absorbed or distributed laterally within the vicinity of the apparatus (10), the result being that the relative position of the apparatus (10) and the sprinkler is secure.

This invention is an improvement over the prior art. Many prior art sprinklers and sprinkler systems do not employ any components which augment the fixed positioning of sprinkler heads. The relevant prior art rely on elements driven vertically into the ground. Stability is derived from a deeply-driven spike or an above-ground structure, such as a tripod, or a continuous border which draws its rigidity from its length.

The apparatus and method of this invention are novel. The apparatus of this invention employs the lateral, not vertical, contact with the soil to provide stability. Each apparatus stands with each sprinkler and has rigidity derived from its individual structure, as opposed to deriving rigidity from a continuous structure with other sprinklers. The method of this invention is distinguished from the prior art. Rather than being driven into the ground, the apparatus of this invention is installed primarily below the ground surface.

It is contemplated that the components of the invention are to be made of metal or plastic. This invention has a novel mechanical construction permitting for the safe, accurate, and easy placement of a sprinkler head. The use of plastic is not intended as limiting the scope of the invention, but is contemplated and described here in order to better illustrate the components of the invention; additionally, the size of the components employed is not intended as a limit as to the invention disclosed or the various embodiments of this invention. It is contemplated that in other embodiments of the invention, components may be made of plastic, metal, or other suitable materials for performing the function of the elements of the invention.

This invention addresses the need to have an underground support apparatus for underground, pop-up type sprinklers. This minimizes exposing the irrigation equipment on the surface of lawns, gardens, golf course, and athletic fields. By minimizing exposure at the ground surface, equipment is less frequently damaged, thus resulting in water savings, from fewer leaks, caused by damaged equipment, increased safety from the irrigation equipment not being moved to undesired and potentially dangerous locations and positions, and lower costs of repair and maintenance.

I claim:

1. An apparatus for securing a lawn sprinkler, comprising:
a base with a top, a bottom, at least one exterior surface, a longitudinal axis, a radius, and an aperture, with a first periphery which opens at the bottom of the base and a second periphery which opens at the top of the base; and,
at least one position securing element
with a horizontal axis, and
at least one blade
with a proximal end attached to the at least one exterior surface of the base, at least one face, a lower side, a distal end, a cross-sectional profile, and at least one side positioned along the horizontal axis.

2. The apparatus of claim 1, wherein
the base is generally cylindrical.

3. The apparatus of claim 1, wherein
the longitudinal axis extends through the center of the base.

4. The apparatus of claim 1, wherein
the longitudinal axis extends through the center of the aperture.

5. The apparatus of claim 1, wherein
the first periphery is adapted to connect to a fluid-conducting conduit.

6. The apparatus of claim 1, wherein
the second periphery is adapted to connect to a discharge element at the top of the base.

7. The apparatus of claim 6, wherein
the discharge element is a sprinkler head.

8. The apparatus of claim 1, wherein
the at least one position securing element has a cross-sectional shape selected from the group consisting of a T-shape, an X-shape, a Y-shape, a cross-shape and an O-shape.

9. The apparatus of claim 1, wherein
the at least one position securing element has a cross-sectional shape comprising
the cross-sectional profile of at least one blade.

10. The apparatus of claim 1, wherein
the at least one position securing element is at least two position securing elements separated by an angle selected from a group consisting of less than ninety degrees and greater than ninety degrees.

11. The apparatus of claim 1, wherein
the proximal end of the at least one blade is parallel to the longitudinal axis.

12. The apparatus of claim 1, wherein
the horizontal axis of the at least one position securing element is perpendicular to the longitudinal axis of the base.

13. The apparatus of claim 1, wherein
the horizontal axis of the at least one position securing element extends tangentially from the exterior surface of the base.

14. The apparatus of claim 1, wherein
the horizontal axis of the at least one position securing element is collinear with the radius of the base.

15. The apparatus of claim 1, wherein
the at least one face of the at least one blade is flat.

16. The apparatus of claim 1, wherein
the lower side of the at least one blade is parallel to the horizontal axis.

17. The apparatus of claim 1, wherein
the lower side of the at least one blade tapers downwardly from the proximal end to the distal end.

18. The apparatus of claim 1, wherein
the base and the proximal end of the at least one position securing element are a single structure.

19. The apparatus of claim 1, wherein
the base and the proximal end of the at least one position securing element are removably attached.

20. An apparatus for securing a lawn sprinkler, comprising:
a generally cylindrical base, with
a top,
a bottom,
at least one exterior surface,
a longitudinal axis
which extends through the center of the base,
a radius, and
an aperture, with
a first periphery, which
opens at the bottom of the base and
is adapted to connect to a fluid-connecting conduit
a second periphery, which
opens at the top of the base and
is adapted to connect to a sprinkler head, and
a central axis
collinear with the longitudinal axis of the base, and
at least one position securing element, with
a horizontal axis,
perpendicular to the longitudinal axis of the base, and collinear with the radius of the base,
at least one blade, with
a proximal end,
removably attached to the at least one exterior surface of the base, and
parallel to the longitudinal axis,
a distal end,
at least one face,
at least one flat side,
a lower side,
which tapers downwardly from the proximal end to the distal end,
a cross-sectional profile, and
at least one side,
positioned along the horizontal axis, and
a cross-sectional shape,
comprising the cross-sectional profile of the at least one blade.

21. A method for securing a lawn sprinkler beneath a ground surface, the lawn sprinkler having a fluid-conducting conduit and a sprinkler head, the method comprising:
connecting the fluid-conducting conduit to an apparatus for securing a lawn sprinkler, said apparatus comprising a base with a top, a bottom, at least one exterior surface, a longitudinal axis, a radius, and an aperture, with a first periphery which opens at the bottom of the base and a second periphery which opens at the top of the base, and, at least one position securing element, with a horizontal axis, and at least one blade, with a proximal end attached to the at least one exterior surface of the base, at least one face, a lower side, a distal end, and at least one side positioned along the horizontal axis, to the first periphery at the bottom of the apparatus;
connecting the sprinkler head to an apparatus for securing a lawn sprinkler, said apparatus comprising a base with a top, a bottom, at least one exterior surface, a longitudinal axis, a radius, and an aperture, with a first periphery which opens at the bottom of the base and a second periphery which opens at the top of the base, and, at least one position securing element, with a horizontal axis, and at least one blade, with a proximal end attached to the at least one exterior surface of the base, at least one face, a lower side, a distal end, and at least one side positioned along the horizontal axis, to the second periphery at the top of the apparatus;
positioning the apparatus in a cavity beneath the ground surface so that the fluid-conducting conduit is positioned generally beneath the apparatus and the sprinkler head is positioned generally above the apparatus but amenable to discharging hydrating fluid at or above the ground surface; and,
surrounding the at least one position securing element of the apparatus with a sufficient volume of dirt or fill material to contact the at least one face of the at least one blade to securely a position for the apparatus beneath the ground surface.
